(19) United States
(12) Patent Application Publication
(10) Pub. No.: US 2023/0058148 A1
(43) Pub. Date: Feb. 23, 2023

(54) DETECTION AND RESOLUTION OF DATA SYNCHRONIZATION CONFLICTS

(71) Applicant: Huawei Technologies Co., Ltd., Shenzhen (CN)

(72) Inventors: Jianjun CHEN, Cupertino, CA (US); Ye LIU, Foster City, CA (US); Chunfeng PEI, San Jose, CA (US); Marko DIMITRIJEVIC, San Jose, CA (US); Kamini Manoharlal JAGTIANI, Los Altos, CA (US)

(73) Assignee: Huawei Technologies Co., Ltd., Shenzhen (CN)

(21) Appl. No.: 18/046,098

(22) Filed: Oct. 12, 2022

Related U.S. Application Data
(63) Continuation of application No. PCT/US2020/027998, filed on Apr. 13, 2020.

(51) Int. Cl. G06F 16/27; G06F 16/23

(52) U.S. Cl. CPC G06F 16/27; G06F 16/2365; G06F 16/2386

(57) ABSTRACT

A computer-implemented method for performing data synchronization between a plurality of computing devices within a communication network includes detecting, by a first computing device of the plurality of computing devices, a changed data field of a plurality of available data fields within a first database table tuple. A bitmap within a plurality of configuration fields of the first database table tuple is updated to indicate a bit location associated with the changed data field. Synchronization data including the changed one or more data fields, the bitmap, and a version number of the first database table tuple within the plurality of configuration fields is sent to a second computing device. A conflict resolution procedure is performed based on a synchronization response received from the second computing device. The synchronization response includes status information associated with the synchronization of the changed data field

### CROSS-REFERENCE TO RELATED APPLICATIONS

This application is a continuation of International Application No. PCT/US2020/027998, filed on Apr. 13, 2020, entitled “DETECTION AND RESOLUTION OF DATA SYNCHRONIZATION CONFLICTS,” the benefit of priority of which is claimed herein, and which application is hereby incorporated herein by reference in its entirety.

### TECHNICAL FIELD

The present disclosure is related to data synchronization techniques in a network-based service infrastructure (such as a Mobile-Backend-as-a-Service, or MBaaS, infrastructure), including detection and resolution of data synchronization conflicts.

### BACKGROUND

Computing devices (e.g., mobile computing devices) are generating more data and are consuming more power to process the increased amount of data. Additionally, with the increased number of portable and mobile devices, data gathered from such devices may need to be accessed and synchronized at multiple network locations within a network architecture for different purposes, including analytics, artificial intelligence (AI) processing, business intelligence processing, or other analytic or data processing functions.

A network architecture may include an MBaaS platform, which may be used as an integrated distributed data management system that can simplify user application (“app”) development as well as data management both on-device and in a network. In an MBaaS system, data generated from different sources often need to be coordinated and synchronized between multiple network nodes in real time. In the meantime, devices are not always connected to the network and, consequently, managing data synchronization and concurrent data modification between multiple computing devices within a network architecture becomes essential for computing and data management efficiency.

### SUMMARY

Various examples are now described to introduce a selection of concepts in a simplified form that is further described below in the detailed description. The Summary is not intended to identify key or essential features of the claimed subject matter, nor is it intended to be used to limit the scope of the claimed subject matter.

According to a first aspect of the present disclosure, there is provided a computer-implemented method for performing data synchronization between a plurality of computing devices within a communication network. The method includes detecting, by a first computing device of the plurality of computing devices, a changed data field of a plurality of available data fields within a first database table tuple. A bitmap within a plurality of configuration fields of the first database table tuple is updated by the first computing device. The bitmap indicates a bit location associated with the changed data field. Synchronization data is sent by the first computing device to a second computing device of the plurality of computing devices, the synchronization data including the changed data field, the bitmap, and a version number of the first database table tuple within the plurality of configuration fields. A conflict resolution procedure is performed by the first computing device based on a synchronization response received from the second computing device. The synchronization response includes status information associated with synchronization of the changed data field with a second database table tuple of the second computing device based on the version number.

In a first implementation form of the method according to the first aspect as such, the status information indicates successful completion of a second computing device data synchronization. The synchronization includes storing the changed data field in the second database table tuple of the second computing device.

In a second implementation form of the method according to the first aspect as such or any preceding implementation form of the first aspect, the version number within the plurality of configuration fields of the first database table tuple is updated by the first computing device using a version number of the second database table tuple provided by the second computing device in the synchronization response. The updating is based on the successful completion of the second computing device data synchronization, and the version number of the second database table tuple being higher than the version number of the first database table tuple.

In a third implementation form of the method according to the first aspect as such or any preceding implementation form of the first aspect, the first computing device determines that a conflict exists when a version number of the second database table tuple provided by the second computing device in the synchronization response is higher than the version number of the first database table tuple.

In a fourth implementation form of the method according to the first aspect as such or any preceding implementation form of the first aspect, the synchronization response includes the version number of the second database table tuple and data from the second database table tuple. The method further includes updating the plurality of available data fields in the first database table tuple with the data from the second database table tuple and updating the version number of the first database table tuple using the version number of the second database table tuple.

In a fifth implementation form of the method according to the first aspect as such or any preceding implementation form of the first aspect, the plurality of configuration fields include synchronization state information associated with the first database table tuple. The synchronization state information indicating one of the following: the first database table tuple has changed and has to synchronize with the second computing device, an ongoing synchronization of the first database table tuple with the second computing device, or the first database table tuple was previously synchronized, without a need for a current synchronization.

In a sixth implementation form of the method according to the first aspect as such or any preceding implementation form of the first aspect, the conflict resolution procedure is performed based on the synchronization response received from the second computing device and the synchronization state information associated with the first database table tuple.

In a seventh implementation form of the method according to the first aspect as such or any preceding implementation form of the first aspect, the bitmap includes a plurality of bits corresponding to the plurality of available data fields within the first database table tuple. Each of the plurality of bits indicates when a corresponding data field of the plurality of available data fields within the first database table tuple has been changed.

In an eighth implementation form of the method according to the first aspect as such or any preceding implementation form of the first aspect, the first database table and the second database table are secure databases associated with a common user of the first computing device and the second computing device, and a common application executing on the first computing device and the second computing device.

According to a second aspect of the present disclosure, there is provided a system for performing data synchronization between a plurality of computing devices within a communication network including a memory that stores instructions and one or more processors in communication with the memory. The one or more processors execute the instructions to detect a changed data field of a plurality of available data fields within a first database table tuple associated with a first computing device of the plurality of computing devices. A bitmap within a plurality of configuration fields of the first database table tuple is updated, the bitmap indicating a bit location associated with the changed data field. Synchronization data is sent to a second computing device of the plurality of computing devices. The synchronization data includes the changed data field, the bitmap, and a version number of the first database table tuple within the plurality of configuration fields. A conflict resolution procedure is performed based on a synchronization response received from the second computing device. The synchronization response includes status information associated with the synchronization of the changed data field with a second database table tuple of the second computing device based on the version number.

In a first implementation form of the system according to the second aspect as such, the status information indicates successful completion of a second computing device data synchronization. The synchronization includes storing the changed data field in the second database table tuple of the second computing device.

In a second implementation form of the system according to the second aspect as such or any preceding implementation form of the second aspect, the one or more processors execute the instructions to update the version number within the plurality of configuration fields of the first database table tuple using a version number of the second database table tuple provided by the second computing device in the synchronization response. The updating is based on the successful completion of the second computing device data synchronization, the version number of the second database table tuple being higher than the version number of the first database table tuple.

In a third implementation form of the system according to the second aspect as such or any preceding implementation form of the second aspect, the one or more processors execute the instructions to determine that a conflict exists when a version number of the second database table tuple provided by the second computing device in the synchronization response is higher than the version number of the first database table tuple.

In a fourth implementation form of the system according to the second aspect as such or any preceding implementation form of the second aspect, the synchronization response includes the version number of the second database table tuple and data from the second database table tuple. The one or more processors execute the instructions to update the plurality of available data fields in the first database table tuple with the data from the second database table tuple. The version number of the first database table tuple is updated using the version number of the second database table tuple.

In a fifth implementation form of the system according to the second aspect as such or any preceding implementation form of the second aspect, the plurality of configuration fields include synchronization state information associated with the first database table tuple. The synchronization state indicates one of the following: the first database table tuple has changed and has to synchronize with the second computing device, an ongoing synchronization of the first database table tuple with the second computing device, or the first database table tuple was previously synchronized, without a need for a current synchronization.

In a sixth implementation form of the system according to the second aspect as such or any preceding implementation form of the second aspect, the one or more processors execute the instructions to perform the conflict resolution procedure based on the synchronization response received from the second computing device and the synchronization state information associated with the first database table tuple.

In a seventh implementation form of the system according to the second aspect as such or any preceding implementation form of the second aspect, the bitmap includes a plurality of bits corresponding to the plurality of available data fields within the first database table tuple. Each of the plurality of bits indicates whether a corresponding data field of the plurality of available data fields within the first database table tuple has been changed.

According to a third aspect of the present disclosure, there is provided a non-transitory computer-readable medium storing instruction for performing data synchronization between a plurality of computing devices within a communication network, that when executed by one or more processors of a first computing device of a plurality of computing devices, cause the one or more processors to perform operations. The operations include detecting a changed data field of a plurality of available data fields within a first database table tuple associated with the first computing device. A bitmap within a plurality of configuration fields of the first database table tuple is updated. The bitmap indicates a bit location associated with the changed data field. Synchronization data is sent to a second computing device of the plurality of computing devices. The synchronization data includes the changed data field, the bitmap, and a version number of the first database table tuple within the plurality of configuration fields. A conflict resolution procedure is performed based on a synchronization response received from the second computing device. The synchronization response includes status information associated with the synchronization of the changed data field with a second database table tuple of the second computing device based on the version number.

In a first implementation form of the non-transitory computer-readable medium according to the third aspect as such, upon execution, the instructions further cause the one or more processors to perform operations including determining that a conflict exists when a version number of the second database table tuple provided by the second computing device in the synchronization response is higher than the version number of the first database table tuple.

In a second implementation form of the non-transitory computer-readable medium according to the third aspect as such, the synchronization response includes the version number of the second database table tuple and data from the second database table tuple. Upon execution, the instructions further cause the one or more processors to perform operations including updating the plurality of available data fields in the first database table tuple with the data from the second database table tuple. The version number of the first database table tuple is updated using the version number of the second database table tuple.

In a third implementation form of the non-transitory computer-readable medium according to the third aspect as such, the plurality of configuration fields includes synchronization state information associated with the first database table tuple. The synchronization state indicates one of the following: the first database table tuple has changed and has to synchronize with the second computing device, an ongoing synchronization of the first database table tuple with the second computing device, or the first database table tuple was previously synchronized, without a need for a current synchronization.

In a fourth implementation form of the non-transitory computer-readable medium according to the third aspect as such, the instructions further cause the one or more processors to perform operations including performing the conflict resolution procedure based on the synchronization response received from the second computing device and the synchronization state information associated with the first database table tuple.

In a fifth implementation form of the non-transitory computer-readable medium according to the third aspect as such, the bitmap includes a plurality of bits corresponding to the plurality of available data fields within the first database table tuple, each of the plurality of bits indicating whether a corresponding data field of the plurality of available data fields within the first database table tuple has been changed.

According to a fourth aspect of the present disclosure, there is provided a system for performing data synchronization between a plurality of computing devices within a communication network. The system includes a detecting means for detecting a changed data field of a plurality of available data fields within a first database table tuple associated with a first computing device of the plurality of computing devices. The system further includes an updating means for updating a bitmap within a plurality of configuration fields of the first database table tuple, the bitmap indicating a bit location associated with the changed data field. The system further includes a communicating means for sending synchronization data to a second computing device of the plurality of computing devices, the synchronization data including the changed data field, the bitmap, and a version number of the first database table tuple within the plurality of configuration fields. The system further includes a conflict detection and resolution means for performing a conflict resolution procedure based on a synchronization response received from the second computing device, the synchronization response including status information associated with the synchronization of the changed data field with a second database table tuple of the second computing device based on the version number.

In a first implementation form of the system according to the fourth aspect as such, the status information indicates successful completion of a second computing device data synchronization, the synchronization including storing the changed data field in the second database table tuple of the second computing device.

In a second implementation form of the system according to the fourth aspect as such, the system further includes means for updating the version number within the plurality of configuration fields of the first database table tuple using a version number of the second database table tuple provided by the second computing device in the synchronization response. The updating is based on the successful completion of the second computing device data synchronization, the version number of the second database table tuple being higher than the version number of the first database table tuple.

Any one of the foregoing examples may be combined with any one or more of the other foregoing examples to create a new embodiment within the scope of the present disclosure.

### BRIEF DESCRIPTION OF THE DRAWINGS

In the drawings, which are not necessarily drawn to scale, like numerals may describe similar components in different views. The drawings illustrate generally, by way of example, but not by way of limitation, various embodiments discussed in the present document.

FIG. 1 is a high-level system overview of a network architecture using data synchronization management (DSM) functionalities, according to some example embodiments.

FIG. 2 is a block diagram illustrating a DSM module and a network DSM module, according to some example embodiments.

FIG. 3 is a block diagram illustrating a device DSM software development kit (SDK) which can be used to configure DSM functionalities for a user computing device, according to some example embodiments.

FIG. 4 is a block diagram of a database table tuple including user fields and system fields which can be used in connection with the DSM functionalities for the user computing device of FIG. 3, according to some example embodiments.

FIG. 5 illustrates a state diagram of synchronization states which are part of the user fields of FIG. 4 and can be used in connection with DSM functionalities, according to some example embodiments.

FIG. 6 is a block diagram illustrating a network DSM SDK that can be used to configure DSM functionalities for a network computing device such as a network synchronization server, according to some example embodiments.

FIG. 7 is a block diagram of a database table tuple including user fields and system fields which can be used in connection with the DSM functionalities for the network synchronization server of FIG. 6, according to some example embodiments.

FIG. 8 is a block diagram illustrating communication exchanges between multiple computing devices performing data synchronization within a communication network, according to some example embodiments.

FIG. 9 illustrates a flow diagram of a method for network-side synchronization conflict detection and resolution, according to some example embodiments.

FIG. 10A, FIG. 10B, and FIG. 10C illustrate flow diagrams of a method for device-side synchronization conflict detection and resolution, according to some example embodiments.

FIG. 11 is a flowchart of a method suitable for performing data synchronization between a plurality of computing devices within a communication network, according to some example embodiments.

FIG. 12 is a block diagram illustrating a representative software architecture, which may be used in conjunction with various device hardware described herein, according to some example embodiments.

FIG. 13 is a block diagram illustrating circuitry for a device that implements algorithms and performs methods, according to some example embodiments.

### DETAILED DESCRIPTION

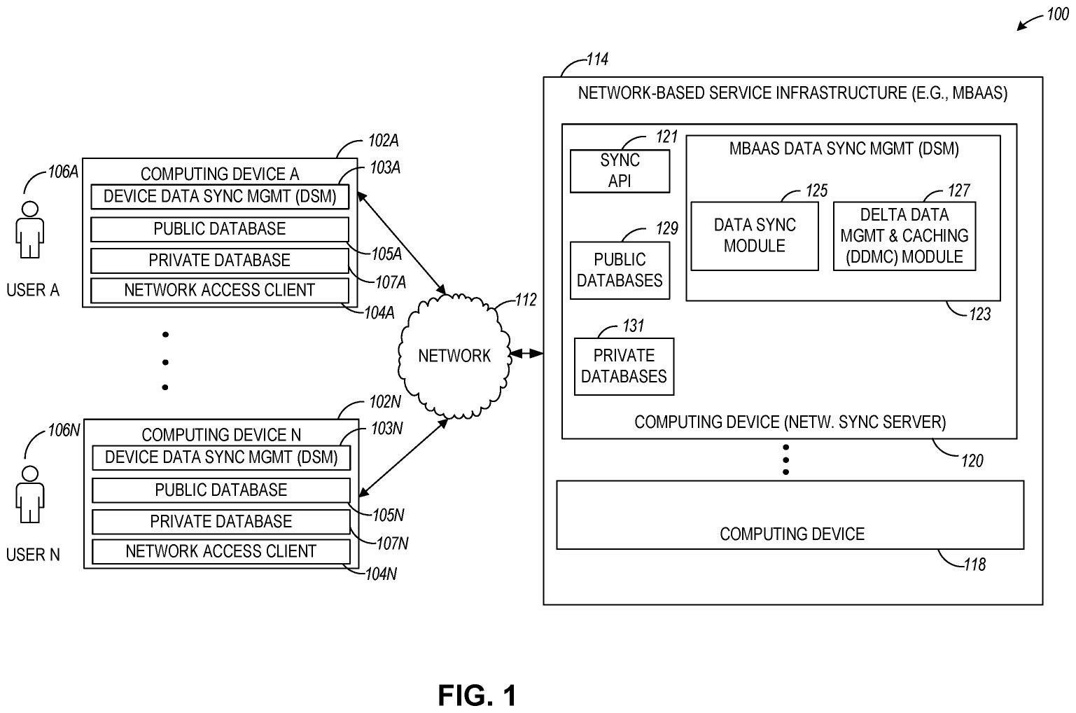

It should be understood at the outset that although an illustrative implementation of one or more embodiments is provided below, the disclosed systems and/or methods described in connection with FIGS. 1-13 may be implemented using any number of techniques, whether currently known or not yet in existence. The disclosure should in no way be limited to the illustrative implementations, drawings, and techniques illustrated below, including the exemplary designs and implementations illustrated and described herein, but may be modified within the scope of the appended claims along with their full scope of equivalents.

In the following description, reference is made to the accompanying drawings that form a part hereof, and in which are shown, by way of illustration, specific embodiments which may be practiced. These embodiments are described in sufficient detail to enable those skilled in the art to practice the inventive subject matter, and it is to be understood that other embodiments may be utilized, and that structural, logical, and electrical changes may be made without departing from the scope of the present disclosure. The following description of example embodiments is, therefore, not to be taken in a limiting sense, and the scope of the present disclosure is defined by the appended claims.

As used herein, the term “network-based service infrastructure” includes a plurality of network devices (also referred to as hosts, nodes, or servers) providing on-demand computing capacity (e.g., to perform data synchronization functionalities via one or more virtual machines or other virtual resources running on the network devices) and storage capacity as a service to a community of end-recipients (e.g., customers of the service infrastructure), where the end-recipients are communicatively coupled to the network devices within the service infrastructure via a network. The customers of the service infrastructure can use one or more computing devices (also referred to as customer devices or user devices) to access and manage the services (including MBaaS) provided by the service infrastructure via the network. The customer devices, the network, and the network-based service infrastructure can be collectively referred to as a “network architecture.” The customers of the service infrastructure can also be referred to as “users.”

As used herein, the term “schema” indicates a column layout for a database table, and the term “tuple” indicates a row layout (i.e., the data) for a database table. As used herein, the term “ObjectType” indicates an abstraction (or mapping) of a database table within a DSM layer accessible via a DSM software development kit (SDK) application programming interface (API) of a computing device. The DSM layer may be used for accessing storage management functionalities for configuring the ObjectTypes and Objects (e.g., by a developer). As used herein, the term “Object” indicates an abstraction (or mapping) of a database table tuple within the DSM layer accessible via the DSM SDK API of the computing device. In this regard, ObjectType maps to a database table schema while an Object maps to a row (or tuple) of a database table schema.

Techniques disclosed herein can be used to configure a DSM module (e.g., for each computing device within a network) to perform concurrent data synchronization conflict detection and conflict resolution between computing devices within a network architecture, such as an MBaaS architecture. In the proposed solution, synchronization of data between a first computing device (e.g., a user device) and a second computing device (e.g., a network-based device such as a network synchronization server) is discussed based on device-side conflict detection/resolution (e.g., performed by the first computing device) as well as network-side conflict detection/resolution (e.g., performed by the second computing device) based on configuring different types of system fields for each database tuple.

More specifically, tuples (or rows of data) within corresponding database tables maintained by the first and second computing devices are configured to include multiple system fields in addition to data fields. The databases may be associated with the same user, on different devices of the user, and the same application executing on the user devices. In each database table tuple, the system fields include a version number of the tuple, a bitmap (including bits that correspond to the data fields of the tuple and indicate which data fields are changed), synchronization state information, and a deletion flag. The synchronization state information indicates one of at least three synchronization states: the tuple has changed and has not yet been synchronized with the second computing device, the tuple synchronization with the second computing device has started and is ongoing, or the tuple was previously synchronized, without a need for the current synchronization. The deletion flag can be set to mark the data fields of the tuple for deletion (e.g., based on user command).

The version number within the system fields of each tuple is used for conflict detection and resolution among tuples since each tuple (or data row corresponding to an Object within an ObjectType) contains a version. The version number is generated by the network-side device (e.g., the second computing device) and it increases monotonically. The version number is generated at the network side, independently from other tuples in a database table.

The bitmap within the system fields of each tuple is used to indicate which user fields within the tuple have changed when synchronization data is selected for synchronization with other computing devices. The DSM module uses the bitmap to collect only the changed data which may be a portion (also referred to as delta data) of all the data in the user fields of the tuple. In this regard, the delta data is a representation of the data changes at the device-side selected for synchronization (e.g., for every tuple that changes, only the changed fields in that tuple are selected via the bitmap and communicated as synchronization data to the network-side for synchronization). Consequently, only the changed fields are synchronized, which results in a reduced data size during communication (resulting in more efficient communication bandwidth usage). Multiple changes on the same row may be accumulated into one delta change and sent to the network side for synchronization. Data changes may be batched for multiple changed tuples associated with multiple tables that have been changed. Additionally, data synchronization requests may be bundled with data changes from the network-side device in one upload/download round trip, which results in fewer network requests and fewer network communication roundtrips.

The DSM module may further use a database version (also referred to as a watermark), which is stored for each database and is configured as the maximum version number selected from all version numbers of the tuples in the database. In this way, when synchronization data and a synchronization request are sent to the network side, the watermark may also be communicated with the synchronization request. The network-side device may use the watermark to determine which data needs to be synchronized back to the device side. In this regard, only the newly changed data (e.g., data associated with version numbers higher than the watermark) are synchronized from the network side to the device side. The watermark may be updated once the synchronization process is finished.

In some aspects, when data is being synchronized from the device side to the network side, an application executing on the first computing device may update the same data that is being synchronized again. A non-blocking mechanism based on the synchronization state information discussed herein may be used by the DSM module to maximize the use of the system and prevent the blocking of data updates until synchronization is completed.

Both device-side and network-side conflict detection/resolution can implement the following example conflict resolution policies using the described system fields: Policy A (which can be used as a default conflict resolution policy)—the last updater wins (if the deletion flag is not set) and delete wins (the last updater may be detected based on the version number, with a higher version number indicating a more recent data update; a delete may be detected by the deletion flag within the system fields); and Policy B (which can be used for custom resolution, such as based on user preference or user input)—the first computing device receives currently committed network data (e.g., network-side data from the second computing device), which is communicated together with currently committed local data (e.g., device-side data stored by the first computing device) to an application for resolution (e.g., based on user input or pre-defined conflict resolution criteria).

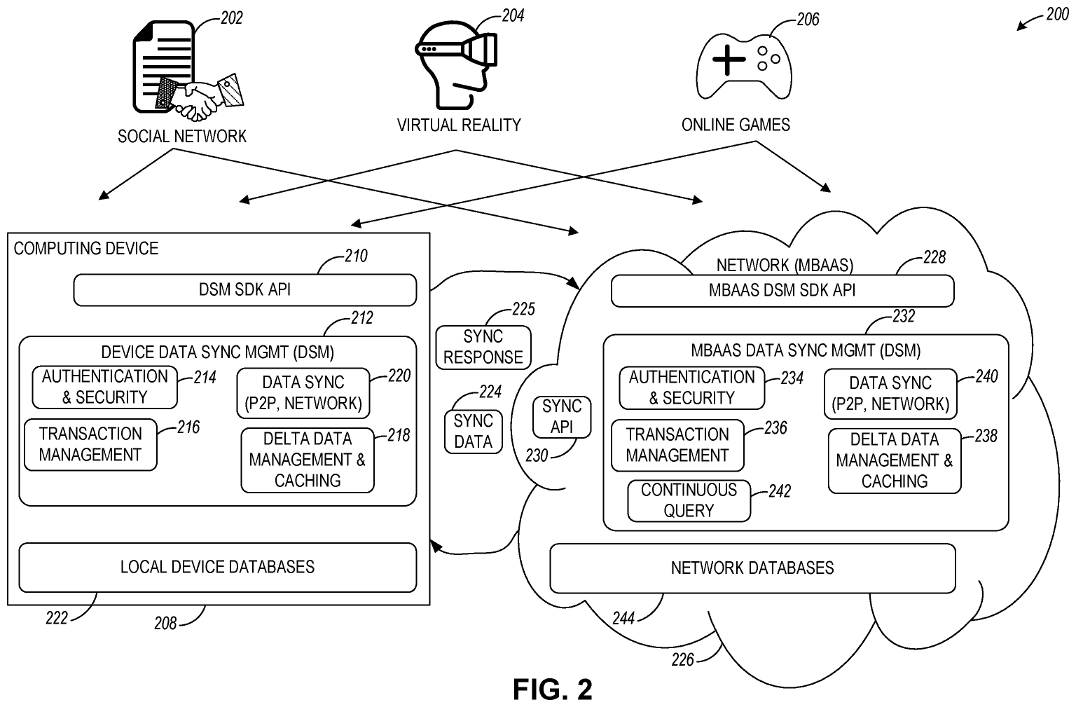

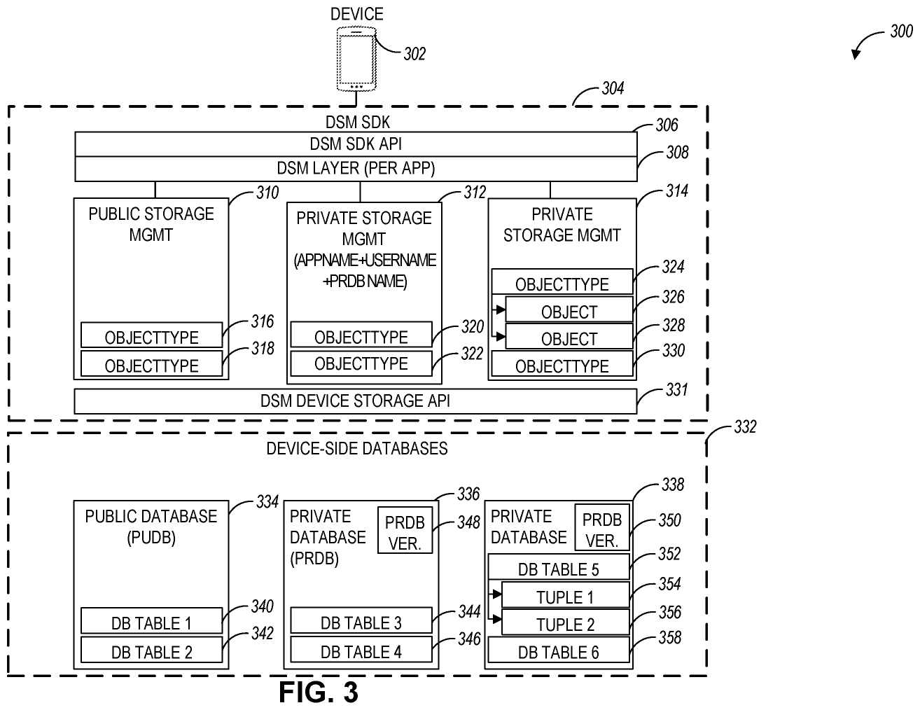

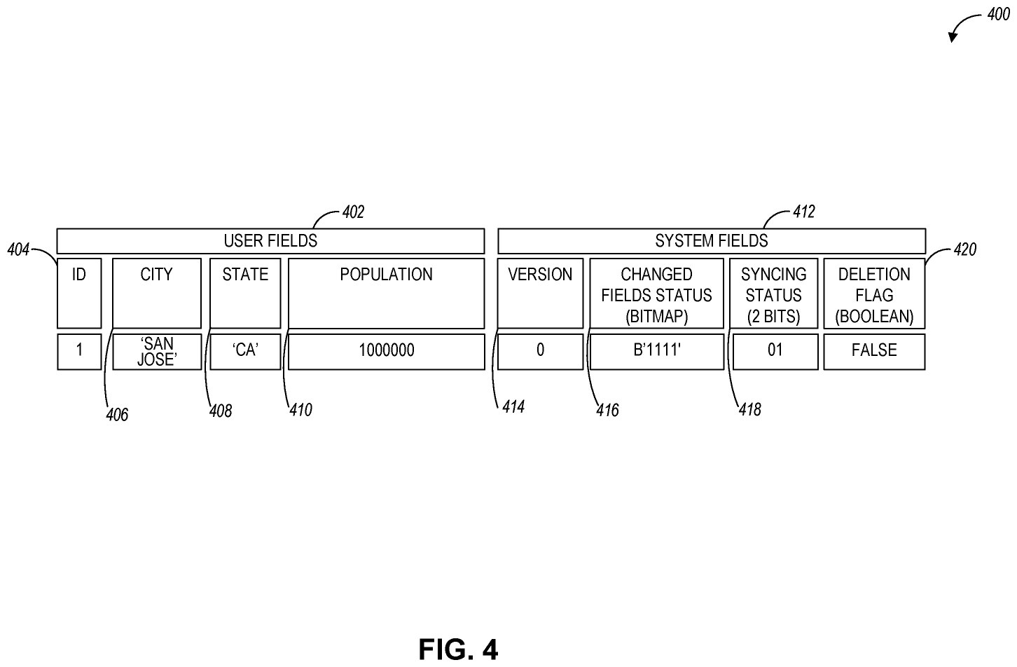

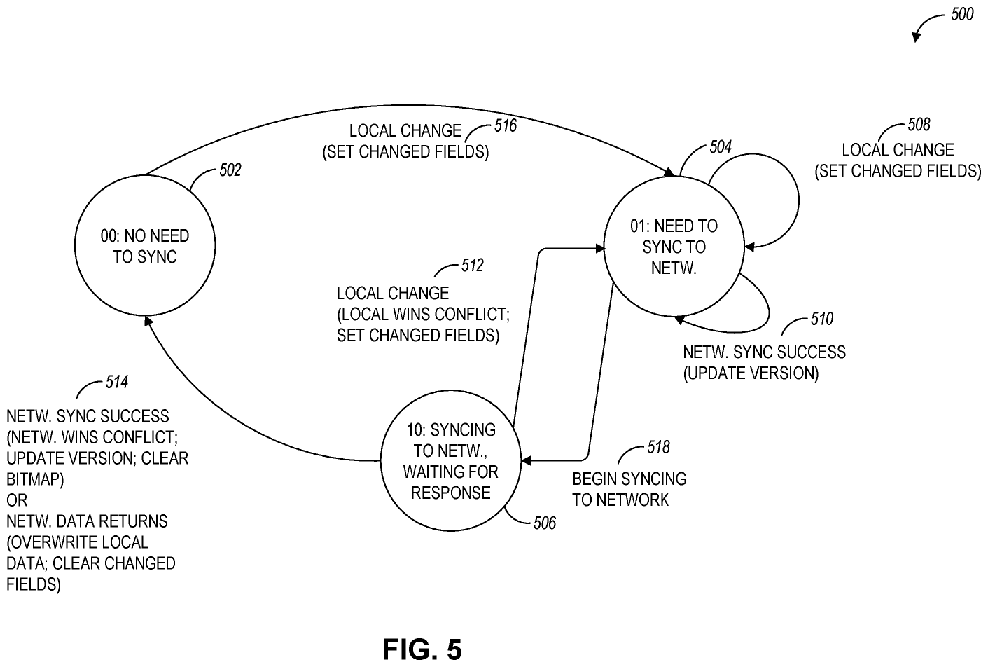

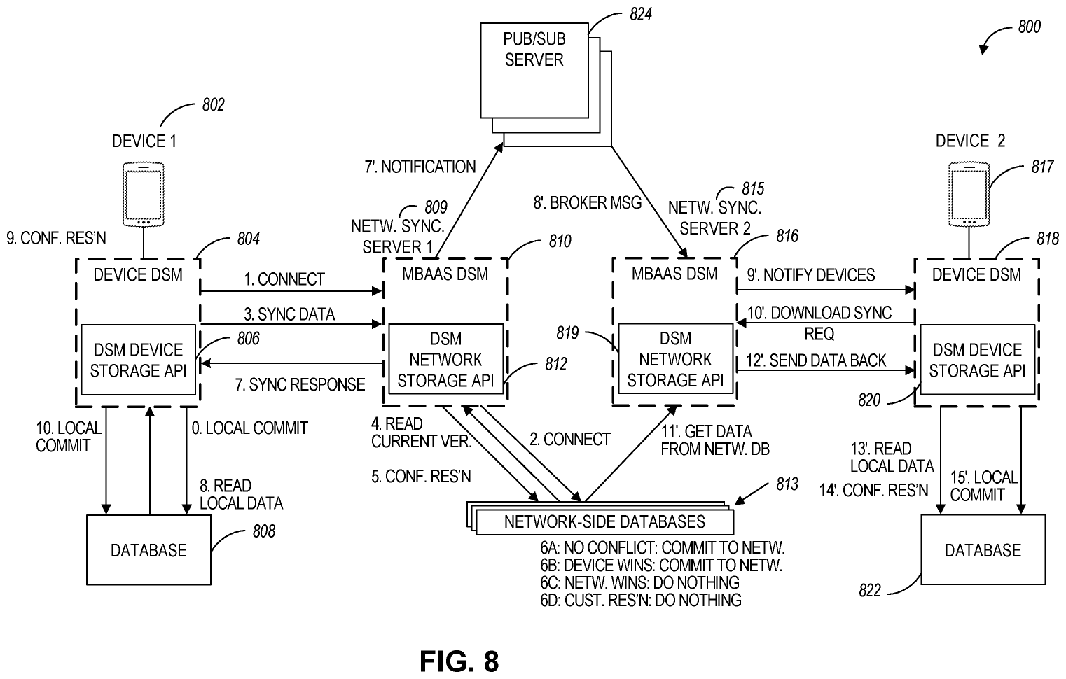

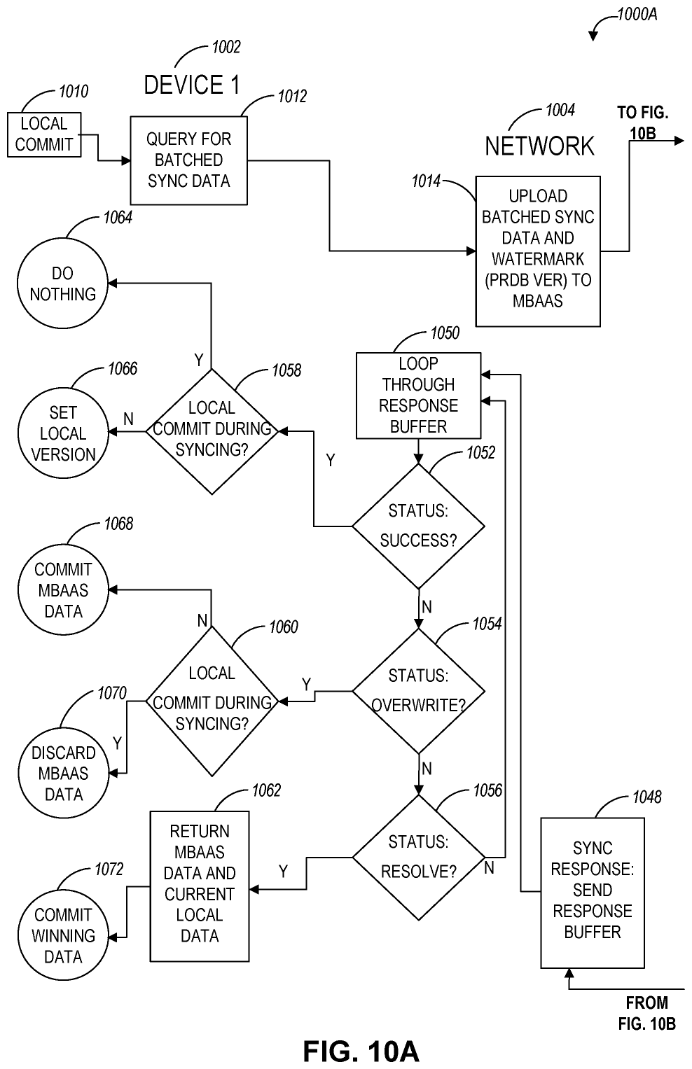

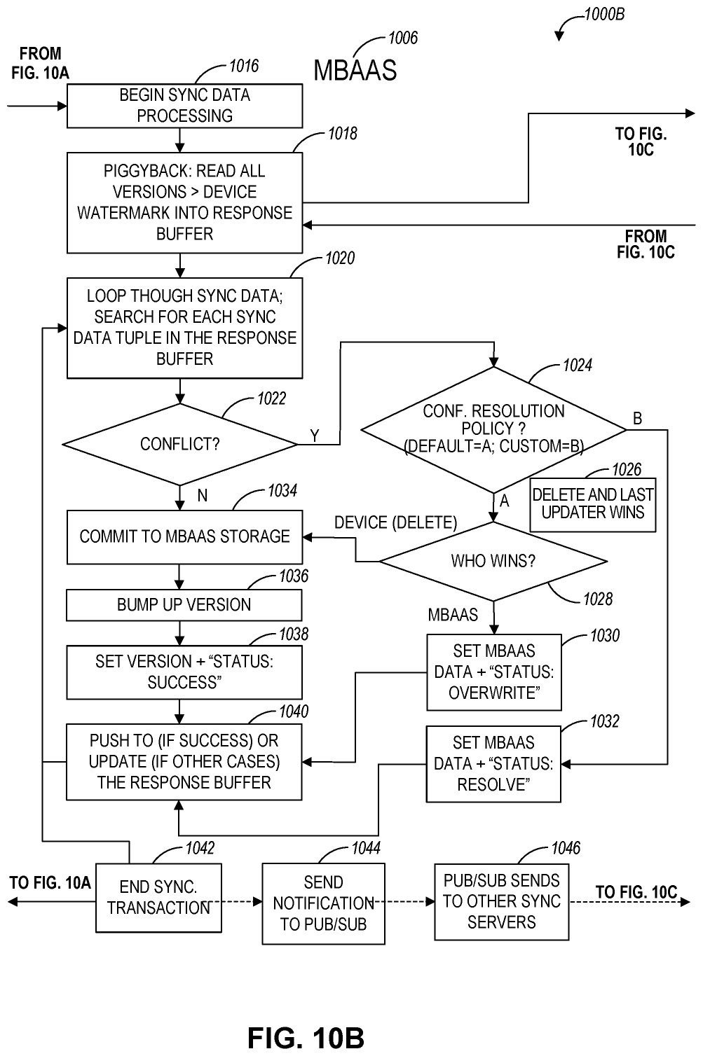

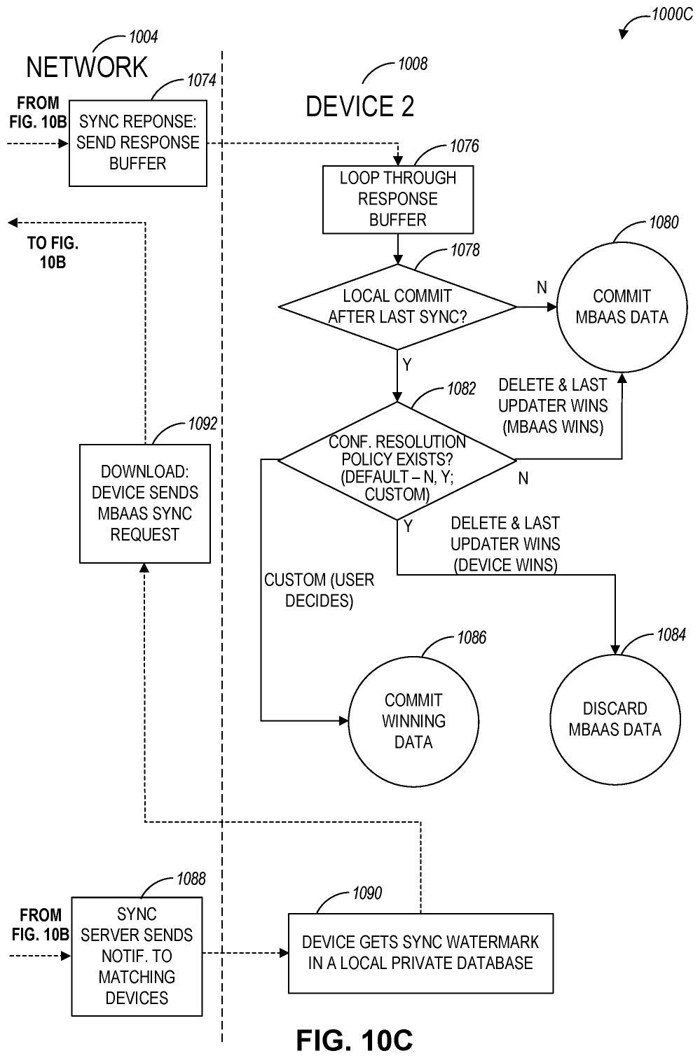

FIG. 1 is a high-level system overview of a network architecture using data synchronization management (DSM) functionalities, according to some example embodiments. Referring to FIG. 1, the network architecture 100 can include a plurality of devices (e.g., user devices) 102A, . . . , 102N (collectively, devices 102) communicatively coupled to a network-based service infrastructure (e.g., MBaaS) 114 via a network 112. The devices 102A, . . . , 102N are associated with corresponding users 106A, . . . , 106N and can be configured to interact with the network-based service infrastructure 114 using a network access client, such as one of clients 104A, . . . , 104N. The network access clients 104A, . . . , 104N can be implemented as web clients or application (app) clients. Devices 102A, . . . , 102N further include device data synchronization management (DSM) modules 103A, . . . , 103N, public databases 105A, . . . , 105N, and private databases 107A, . . . , 107N respectively. The DSM modules 103A, . . . , 103N are configured to perform data synchronization functionalities, such as functionalities discussed in connection with FIG. 2, FIG. 3, FIG. 4, FIG. 5, FIG. 8, FIG. 10A, FIG. 10B, and FIG. 10C.

Users 106A, . . . , 106N may be referred to generically as “a user 106” or collectively as “users 106.” Each user 106 may be a human user (e.g., a human being), a machine user (e.g., a computer configured by a software program to interact with the devices 102 and the network-based service infrastructure 114), or any suitable combination thereof (e.g., a human assisted by a machine or a machine supervised by a human). The users 106 are not part of the network architecture 100 but are each associated with one or more of the devices 102 and may be users of the devices 102 (e.g., the user 106A may be an owner of the device 102A, and the user 106N may be an owner of the device 102N). For example, device 102A may be a desktop computer, a vehicle computer, a tablet computer, a navigational device, a portable media device, or a smartphone belonging to user 106A. Users 106A, . . . , 106N can use devices 102A, . . . , 102N to access services (e.g., MBaaS-related services including data synchronization) provided by the network-based service infrastructure 114. In this regard, users 106 can also be referred to as “customers 106” or “tenants 106” of the network-based service infrastructure 114.

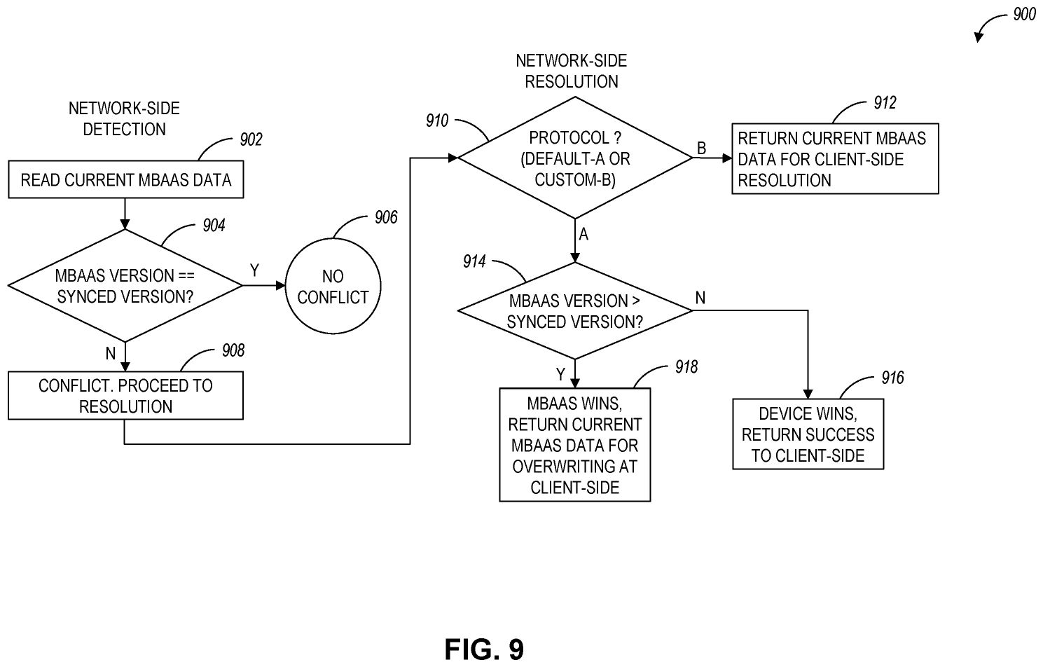

The network-based service infrastructure 114 can include a plurality of computing devices (e.g., network synchronization servers) 118, . . . , 120. FIG. 1 illustrates in greater detail network synchronization server 120, which includes an MBaaS DSM module 123, synchronization (or sync) application programming interface (API) 121, public databases 129, and private databases 131. The MBaaS DSM module 123 (which may perform similar functions to the device DSM modules 103A, . . . , 103N) may include a data synchronization module 125 and a delta data management and caching (DDMC) module 127. The DDMC module 127 comprises suitable circuitry, logic, interfaces, and/or code and is configured to detect changed data (e.g., changed data within one or more database table tuples of a database table stored in the private databases 131) and gather (e.g., store in the temporary cache of the network synchronization server 120) synchronization data which includes the detected change data for subsequent synchronization with one or more computing devices. The data sync module 125 comprises suitable circuitry, logic, interfaces, and/or code and is configured to perform conflict detection and resolution in connection with data synchronization using the synchronization data gathered by the DDMC module 127. A more detailed diagram of the device and MBaaS DSM modules is provided in FIG. 2. A more detailed description of device-side and network-side conflict detection and resolution in connection with data synchronization is provided in connection with FIGS. 9-10C.

Any of the devices shown in FIG. 1 may be implemented in a general-purpose computer modified (e.g., configured or programmed) by software to be a special-purpose computer to perform the functions described herein for that machine, database, or device. As used herein, a “database” is a data storage resource that stores data structured as a text file, a table, a spreadsheet, a relational database (e.g., an object-relational database, a NoSQL database, a network or graph database), a triple store, a hierarchical data store, or any suitable combination thereof. Additionally, data accessed (or stored) via an application programming interface (API) or remote procedure call (RPC) may be considered to be accessed from (or stored in) a database. Moreover, any two or more of the devices or databases illustrated in FIG. 1 may be combined into a single machine, database, or device, and the functions described herein for any single machine, database, or device may be subdivided among multiple machines, databases, or devices.

Network 112 may be any network that enables the communication between or among machines, databases, and devices (e.g., devices 102A, . . . , 102N and devices 118, . . . , 120 within the network-based service infrastructure 114). Accordingly, network 112 may be a wired network, a wireless network (e.g., a mobile or a cellular network), or any suitable combination thereof. Network 112 may include one or more portions that constitute a private network, a public network (e.g., the Internet), or any suitable combination thereof.

In an example data synchronization operation, a DSM module (e.g. DSM module 103A of device 102A associated with the user 106A) monitors data changes within the private database 107A. For example, user 106A is using an app executing on device 102A, which app stores data in a database table in the private database 107A. The DSM module 103A (which may also include a data sync module and a DDMC module) detects changed/updated data in the database table and initiates synchronization of the change data with the network-based service infrastructure 114 (e.g., network synchronization server 120) to synchronize the data with a corresponding database table associated with user 106A and stored in the private databases 131 of the network synchronization server 120. The DSM module 103A communicates the synchronization data (e.g., the detected changed data) to the MBaaS DSM module 123 via the sync API 121. The MBaaS DSM module 123 performs conflict detection and resolution and synchronizes the data with the corresponding database table in the private databases 131. The network synchronization server 120 may be communicatively coupled to one or more other computing devices associated with user 106A (e.g., as illustrated in FIG. 8) in this case, the network synchronization server 120 communicates synchronization data to the additional computing devices to trigger device-side synchronization using the device DSM module of each of the additional computing devices.

FIG. 2 is a block diagram 200 illustrating a device DSM module and a network (e.g., MBaaS) DSM module, according to some example embodiments. Referring to FIG. 2, the device DSM module 212 is within a computing device 208, and the MBaaS DSM module 232 is within a network synchronization server within network 226 (which can include an MBaaS). Synchronization data 224 is communicated from the computing device 208 to the MBaaS DSM module 232, and a synchronization response 225 is communicated from the MBaaS DSM module 232 to the computing device 208. Device 208 includes a DSM software development kit (SDK) API 210, the DSM module 212, and local device databases 222. The DSM module 212 includes an authentication and security module 214, a transaction management module 216, a delta data management and caching (DDMC) module 218, and a data synchronization module 220. The network 226 includes a synchronization API 230, an MBaaS DSM SDK API 228, an MBaaS DSM module 232, and network databases 244. The MBaaS DSM module 232 includes an authentication and security module 234, a transaction management module 236, a DDMC module 238, a data synchronization module 240, and a continuous query module 242.

The authentication and security modules 214 and 234 are configured to perform authentication and security functions in connection with data synchronization (e.g., user authentication, data encryption/decryption, etc.). The transaction management modules 216 and 236 are configured to manage the configuration and execution of database transactions, such as transactions associated with device databases 222 and network databases 244. The functionalities of DDMC and data synchronization modules are explained hereinabove in connection with FIG. 1. The continuous query module 242 is used to configure queries that are continuously executing and generating results as data stored within the network databases 244 changes.

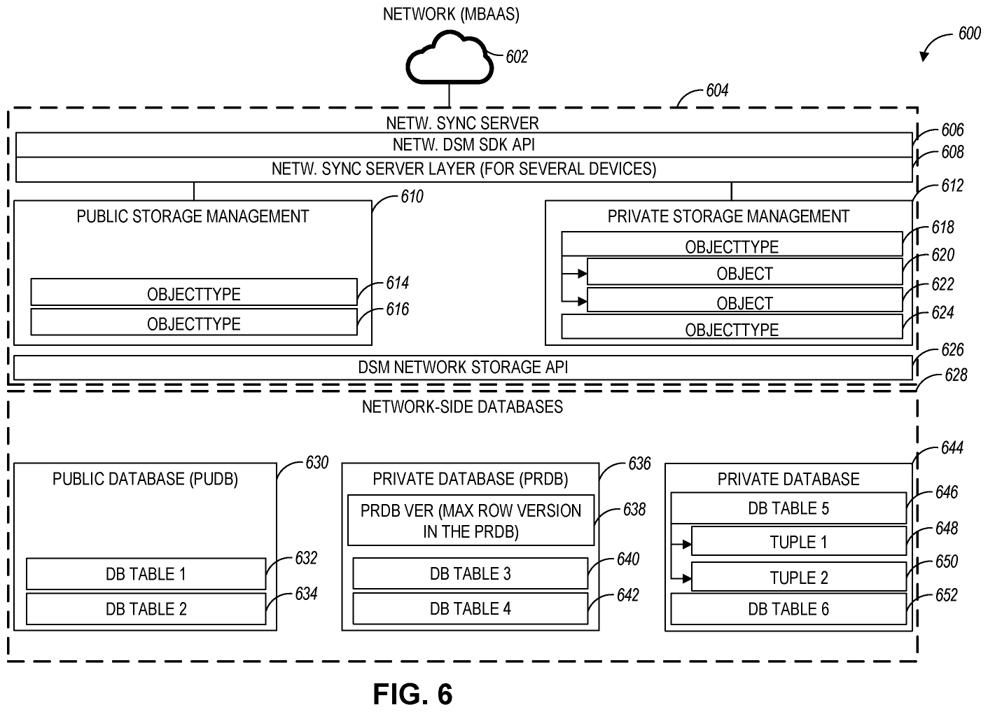

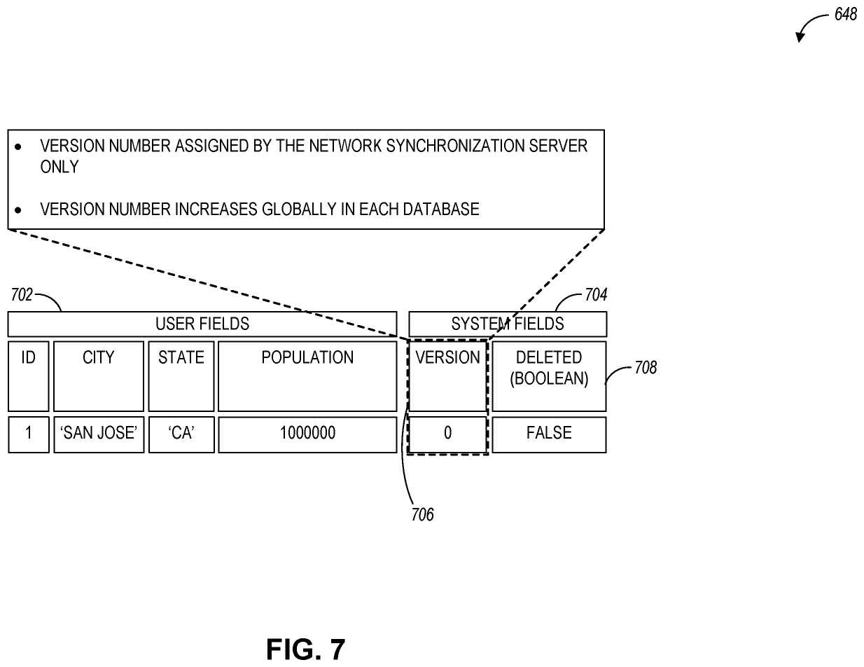

The DSM SDK API 210 is used (e.g., by a user/developer) to access device 208 and configure public storage management and private storage management functions associated with the DSM module (e.g., as described in greater detail in connection with FIGS. 3-5). Similarly, the MBaaS DSM SDK API 228 is used (e.g., by a user/developer) to access a network synchronization server (e.g., a server hosting the MBaaS DSM module 232) and configure public storage management and private storage management functions associated with the DSM module (e.g., as described in greater detail in connection with FIGS. 6-7).

A user (e.g., the user 106A of FIG. 1) may access (e.g., via device 208) different types of applications including social network applications 202, virtual reality applications 204, and online gaming applications 206, which can maintain application data stored in a predefined format within local device databases 222 as well as network databases 244, which may include public and private databases.

In operation, the applications 202-206 may store data in multiple network locations (e.g., the same user may use the same application on multiple devices) and data may need to be synchronized between corresponding DSM modules (e.g., 212 and 232) at the multiple network locations using techniques disclosed herein. When the device DSM module 212 detects changed data, synchronization data 224 may be prepared using the changed data and communicated to the MBaaS DSM module 232 for synchronization via the synchronization API 230. Conflict detection and resolution in connection with the synchronization may be performed at the device-side (e.g., by the device DSM module 212, as discussed in connection with FIGS. 10A-10C) or at the network-side (e.g., by the MBaaS DSM module 232, as discussed in connection with FIG. 9) using system data (e.g., as discussed in connection with FIGS. 3-4) communicated as part of the synchronization data 224. In some aspects, network 226 determines whether the data that is being synchronized between device 208 and network 226 (which data is associated with a user of device 208 and an application executing on device 208) has to be synchronized with other devices (e.g., when the user of device 208 uses the same application on other devices). In this aspect, network 226 can initiate additional synchronization of the other devices (e.g., as discussed in connection with FIG. 8).

FIG. 3 is a block diagram 300 illustrating a device DSM software development kit (SDK) 304 which can be used to configure DSM functionalities for a user computing device 302, according to some example embodiments. Referring to FIG. 3, the DSM SDK 304 includes a DSM SDK API 306 which can be used to connect with the DSM layer 308 and access a public storage management module 310 and private storage management modules 312 and 314. Each of the storage management modules 310-314 may be used to configure ObjectTypes and associated Objects, which map to respective database tables and database table tuples. The DSM SDK 304 further includes a DSM device storage API 331 for accessing the device-side databases 332, including the public database 334 and the private databases 336 and 338.

For example, the public storage management module 310 (which manages database table configuration for the public database 334) is used to configure ObjectTypes 316 and 318 corresponding to database tables 340 and 342 within the public database 334. The private storage management module 312 (which manages database table configuration for the private database 336) is used to configure ObjectTypes 320 and 322 corresponding to database tables 344 and 346 within the private database 336. The private storage management module 314 (which manages database table configuration for the private database 338) is used to configure ObjectTypes 324 (including Objects 326 and 328) and 330 corresponding to database tables 352 (with tuples 354 and 356) and 358 within the private database 338.

As illustrated in FIG. 3, the private storage management module 312 is associated with a specific application (indicated by “AppName”), a user (indicated by “UserName”), and a private database (PRDB) (indicated by “PRDBName”). When synchronization data is collected and communicated to the network synchronization server in the MBaaS, additional information such as the application name, the username, and the originating private database where the synchronization data is collected from may also be identified to assess the network synchronization server in identifying the corresponding private database at the network-side.

FIG. 4 is a block diagram of a database table tuple 400 including user fields 402 and system fields 412 which can be used in connection with the DSM functionalities for the user computing device of FIG. 3, according to some example embodiments. Referring to FIG. 4, the user fields 402 of the database table tuple 400 include an ID field 404, a city field 406, a state field 408, and a population field 410. The system fields 412 of the database table tuple 400 include a version number 414, a bitmap 416, synchronization status bits 418, and a deletion flag 420.

The synchronization status bits 418 indicate one of at least three synchronization states: the tuple has changed and has to synchronize with the second computing device, the tuple synchronization with the second computing device has started and is ongoing, or the tuple was previously synchronized, without a need for the current synchronization. The synchronization states are discussed in greater detail in connection with FIG. 5. The deletion flag 420 can be set when the data fields of the tuple are marked for deletion (e.g., based on user command).

Version number 414 within the system fields 412 of each tuple is used for conflict detection and resolution among tuples since each tuple (or data row corresponding to an Object within an ObjectType) contains a version. Version number 414 is generated by the network-side device (e.g., the network synchronization server) and it increases monotonically.

The bitmap 416 within the system fields 412 of each tuple is used to indicate which user fields within the tuple have changed when synchronization data is selected for synchronization with other computing devices. For example, database table tuple 400 includes 4 fields and the bitmap 416 may include 4 bits (e.g., a bitmap of 1111 indicates all 4 fields are changed, a bitmap 0000 indicates none of the fields are changed, a bitmap 0100 indicates the second field has changed, and so forth). A value of 1 in the bitmap may indicate the corresponding field is changed, and a value of 0 may indicate the field is unchanged (or vice versa, 1 indicates an unchanged field and 0 indicates a changed field).

The DSM module uses bitmap 416 to collect only the changed data indicated by the bitmap which may be a portion (also referred to as delta data) of all the data in the user fields 402. In this regard, the delta data is a representation of the data changes at the device-side selected for synchronization (e.g., for every tuple that changes, only the changed fields in that tuple are selected via the bitmap and communicated as synchronization data to the network-side for synchronization). Multiple changes of data in the same tuple may be accumulated into one data change and sent as synchronization data to the network synchronization server.

In some aspects, each of the private databases (e.g., 336 and 338) can include a PRDB version number, such as PRDB version numbers 348 and 350. The PRDB version number is the maximum version number of all version numbers of the database table tuples stored in the PRDB. In this regard, when synchronization data is sent to the network side, the PRDB version may be communicated as part of the synchronization data (or as part of a synchronization request communicated with the synchronization data). The network synchronization server may use the PRDB version to determine which data needs to be synced back to the device. More specifically, only newly changed data with a version number that is higher than the PRDB version is synced from the network for the device. When the sync process finishes, the PRDB versions of each private database can be updated based on the version numbers of the database tuples currently stored in each private database

FIG. 5 illustrates a state diagram 500 of synchronization states which are part of the user fields (e.g., synchronization status bits 418) of FIG. 4 and can be used in connection with DSM functionalities discussed herein, according to some example embodiments. Referring to FIG. 5, the values of the synchronization status bits can include 00 (corresponding to state 502, indicating that the data does not change and does not need to be synchronized), 01 (corresponding to state 504, indicating that data is changed and needs to be synchronized), and 10 (corresponding to state 506, indicating that the data is being synchronized and synchronization is not completed yet).

FIG. 5 further illustrates different transitions between states 502, 504, and 506.

If the synchronization status bits are 00 and the data (e.g., one or more of the user fields 402) is modified locally (e.g., at operation 516), the status bits are changed to 01 (state 504) and the bitmap 416 is updated (e.g., by the DDMC module) to indicate which fields have changed.

If the synchronization status bits are 01 and the data is modified locally at operation 508, the changed fields status field (or bitmap 416) is updated based on the new data modification.

If the synchronization status bits are 01, and the network synchronization response is obtained indicating the synchronization is successful, then (at operation 510) the tuple version number is updated in the local device databases using the version number communicated with the synchronization response. If the synchronization response includes network tuple data from the network synchronization server, then the tuple version number is updated in the local device databases using the version number communicated with the synchronization response, and the network tuple data and the corresponding local tuple data are combined in the local database.

When the synchronization status bits are 01 and synchronization data is generated by the DSM module based on detected changes in data within a database table tuple, at operation 518, the synchronization data and a synchronization request (which may include one or more of the system fields 412, the PRDB version of the private database that stores the synchronization data, and information identifying the application using the synchronization data, the user, and the private database) are communicated (e.g., by the data sync module within the DSM module) to the network synchronization server 120 for synchronization. The state then transitions from state 504 to state 506. In this regard, a DSM module may detect that data within a database table tuple is modified and may change the synchronization status bits to 01. The DSM module may then proceed and prepare the synchronization data based on detecting the changed data. After the synchronization data is prepared based on the changed data in the database table tuple, the DSM module communicates the synchronization data to the network synchronization server and changes the synchronization status bits in the database table tuple with the detected changed data to 10 (indicating a state transition from state 504 to state 506). In an example embodiment, the DSM module may detect changes in data within multiple database table tuples and may prepare the synchronization data based on the detected changed data within the multiple database table tuples.

If the synchronization status bits are 10 and the data is modified locally, at operation 512, the state transitions from state 506 to state 504, and then the changed fields status field (or bitmap 416) is updated based on the local data modification.

If the synchronization status bits are 10, the network data response is obtained. If the network data update is successful (including network conflict resolution), then (at operation 514) the tuple version number is updated in the local device databases using the version number communicated with the synchronization response, the changed fields status field (or bitmap 416) is reset, and state transitions from state 506 to state 502.

Alternatively, if the synchronization status bits are 10, the network data response is received indicating the data on the device side should be overwritten. Then at operation 514, the data at the device side is overwritten using the received network data, the changed fields status field (or bitmap 416) is reset, and the state transitions from state 506 to state 502.

FIG. 6 is a block diagram 600 illustrating a network DSM SDK API 606 which can be used to configure DSM functionalities for a network computing device such as a network synchronization server 604, according to some example embodiments. Referring to FIG. 6, the network synchronization server 604 is coupled to a network 602 (e.g., a cloud-based network) and executes a DSM SDK (not illustrated in FIG. 6), which includes the network DSM SDK API 606. The DSM SDK API 606 is used to connect with the network synchronization server layer 608 and access a public storage management module 610 and a private storage management module 612. Each of the storage management modules 610 and 612 may be used to configure ObjectTypes and associated Objects, which map to respective database tables and database table tuples in the network-side databases 628. The DSM SDK further includes a DSM network storage API 626 for accessing the network-side databases 628, including the public database (PUDB) 334 and the private databases (PRDBs) 636 and 638.

For example, the public storage management module 610 (which manages database table configuration for the public database 630) is used to configure ObjectTypes 614 and 616 corresponding to database tables 632 and 634 within the public database 630. A private storage management module 612 (which manages database table configuration for the private databases 636 and 644) is used to configure ObjectTypes 618 (including Objects 620 and 622) and 624 corresponding to database tables 640 and 642 (within the private database 636) or database tables 646 (with tuples 648 and 650 corresponding to Objects 620 and 622) and 652 within the private database 644. The private database 636 further includes a PRDB version number 638, which is the maximum version number of all version numbers of the database table tuples stored in the PRDB.

In some aspects, the private storage management module 612 is associated with the following identifiers: a specific application (indicated by “AppName”), a user (indicated by “UserName”), and a private database (PRDB) (indicated by “PRDBName”). When synchronization data is received from the device side together with a synchronization request, the synchronization request includes one or more of these identifiers so that the network synchronization server selects the appropriate private database from the network-side databases 628 for synchronization.

FIG. 7 is a block diagram of a database table tuple 648 stored in a private database of the network-side databases 628, including user fields 702 and system fields 704 which can be used in connection with the DSM functionalities for the network synchronization server of FIG. 6, according to some example embodiments. Referring to FIG. 7, the user fields 702 of the database table tuple 648 include an ID field, a city field, a state field, and a population field. The system fields 704 of the database table tuple 648 include version number 706 and a deletion flag 708.

The version number 706 within the system fields 704 of the tuple is used for conflict detection and resolution among tuples since each tuple (or data row corresponding to an Object within an ObjectType) contains a version number. The version number 706 is generated by the network synchronization server) and it increases globally, in each database.

FIG. 8 is a block diagram 800 illustrating communication exchanges between multiple computing devices performing data synchronization within a communication network, according to some example embodiments. Referring to FIG. 8, diagram 800 illustrates sequentially numbered communications between a first computing device 802, a first network synchronization server 809, a second network synchronization server 815, and a second computing device 817.

At operation 0, the device DSM module 804 uses the DSM device storage API 806 to perform a local commit operation in database 808, which can include updating one or more user fields 402 of the database table tuple 354 stored in the private database 338. The DSM module 804 updates the bitmap 416 and the synchronization status bits 418 to trigger synchronization with the network synchronization server 809.

At operation 1, computing device 802 establishes a communication link with the network synchronization server 809. At operation 2, the MBaaS DSM module 810 of the network synchronization server 809 uses the DSM network storage API 812 to establish a connection with network-side databases 813.

At operation 3, synchronization data is communicated from the computing device 802 to the network synchronization server 809, the synchronization data including a synchronization request, the changed data within the database table tuple 354 as well as the system fields 412 including the bitmap 416 and the version number 414. The synchronization data may further include PRDB version number 350 of private database 338 storing database table 352 that includes tuple 354. When the synchronization data is communicated at operation 3, the synchronization status bits 418 will change to indicate state 506 (the data is being synchronized and synchronization is not completed yet).

At operation 4, the MBaaS DSM module 810 obtains the version number 414 from the received synchronization data and, at operation 5, performs a network-side conflict detection and resolution (e.g., as illustrated in greater detail in FIG. 9). One of operations 6A, 6B, 6C, and 6D is performed as a result of the conflict detection and resolution.

At operation 6A, no conflict is detected and the synchronization data is committed into the network-side databases 813. At operation 6B, the computing device 802 wins, and the synchronization data is committed to the network-side databases 813. At operation 6C, the network synchronization server 809 wins, and no data is committed on the network side. At operation 6D, a custom resolution takes place based on a custom conflict resolution protocol. The network-side data is communicated back to the computing device and no data is committed on the network side.

At operation 7, a synchronization response based on the conflict resolution is communicated back from the network synchronization server 809 to the computing device 802. At operation 8, the device DSM module 804 reads the local data that corresponds to the synchronization response and, at operation 9, performs a conflict resolution procedure (e.g., as discussed in connection with FIGS. 10A-10C). At operation 10, a local commit of the data after the conflict resolution procedure is performed using the device-side database 808.

In an example embodiment, the network synchronization server 809 may detect that synchronization data received from computing device 802 is associated with another computing device 817 (which may be associated with the same user using device 802) which is in communication with a different network synchronization server 815. In this case, at operation 7′, the network synchronization server 809 communicates a notification to the publisher/subscriber (PUB/SUB) server 824 which relays the notification and communicates a brokered message to the network synchronization server 815 at operation 8′. Operations 7 and 7′ are associated with different operation sequences, with both operations 7 and 7′ occurring after conflict detection and resolution (e.g., operation 5 and one of operations 6A-6D) have been completed. If the synchronization data received from device 802 is not associated with another computing device (e.g., device 817), then operations 7′-15′ will not be performed.

At operation 9′, the MBaaS DSM module 816 of the network synchronization server 815 notifies the device DSM module 818 of computing devices 817 of updated data available at the network-side databases 813. At operation 10′, the device DSM module 818 communicates a download synchronization request to the MBaaS DSM module 816 of the network synchronization server 815. At operation 11′, the synchronized (updated) data is read from the network-side databases 813 using the DSM network storage API 819, and, at operation 12′, the synchronized data is communicated back to the device DSM module 818 of computing devices 817. At operation 13′, the device DSM module 818 uses the DSM device storage API 820 to access corresponding local data from database 822. At operation 14′, the device DSM module 818 performs a conflict resolution procedure and, at operation 15′, performs a local commit and stores the result from the conflict resolution into the database 822.

In some aspects, database 808, database 822, and one or more of the network-side databases 813 are secure databases (e.g., which can be accessed using secure credentials) associated with a common user of (and a common application executing on) computing devices 802, 817 and servers 810, 816.

FIG. 9 illustrates a flow diagram of method 900 for network-side synchronization conflict detection and resolution, according to some example embodiments. At operation 902, the MBaaS DSM module 810 reads current MBaaS data from the network-side databases 813 which corresponds to the received synchronization data. More specifically, the synchronization data may include one or more of the application name, user name, or private database name associated with the private database 338 that stores the changed data. The MBaaS DSM module 810 may use such information to determine the private database within the network-side databases 813 that corresponds to the private database 338, for the same user and application. At operation 904, the MBaaS DSM module 810 determines whether the version number (or MBaaS version) of the corresponding tuple in the network-side private database is equal to the version number received with the synchronization data. If the two version numbers are equal then a no conflict determination is made at operation 906. If the two versions are different, at operation 908, it is determined that a conflict exists and processing continues to conflict resolution.

At operation 910, the MBaaS DSM module 810 determines whether a default conflict resolution protocol (e.g., protocol A) or a custom conflict resolution protocol (e.g., particle B) is configured by the MBaaS. If a custom conflict resolution protocol is used, at operation 912, the current MBaaS data is returned or client-side conflict resolution. If a default conflict resolution protocol is used, at operation 914, it is determined whether the MBaaS version number is greater than the version number received with the synchronization data. If the MBaaS version number is not greater, at operation 916, the computing device 802 wins the conflict resolution and a success indicator is returned to the DSM module 804. If the MBaaS version is greater than the version number received with the synchronization data, at operation 918, the network synchronization server 809 wins, and the current MBaaS data is returned to the device DSM module 804 for overwriting.

FIG. 10A, FIG. 10B, and FIG. 10C illustrate flow diagrams of methods 1000A, 1000B, and 1000C for device-side synchronization conflict detection and resolution between computing device 1002, MBaaS 1006, a computing device 1008 (all coupled via network 1004), according to some example embodiments. At operation 1010, a local commit is performed at computing device 1002, resulting in a changed/updated database table tuple. At operation 1012, a synchronization query is generated with synchronization data based on the local commit operation. Synchronization data may include, for example, updated database table tuple 354, corresponding system fields of the tuple, and the PRDB version number (also referred to as a watermark) 350 of the private database 338. At operation 1014, synchronization data including the watermark is uploaded via network 1004 to the MBaaS 1006.

At operation 1016, synchronization data processing at the MBaaS 1006 is initiated (e.g., by an MBaaS DSM module within a network synchronization server). At operation 1018, a piggyback operation is performed where all database table tuples with versions greater than the watermark are stored in a response buffer. At operation 1020, a loop through the received synchronization data is performed and the database table tuple in the synchronization data is matched with a corresponding tuple in the response buffer. At operation 1022, it is determined whether a conflict exists based on a comparison of the version numbers of the two tuples. If a conflict exists, at operation 1024, a conflict resolution policy is determined. For example, a default or a custom conflict resolution policy may be predefined or used in the MBaaS 1006. If a custom conflict resolution policy is configured for the MBaaS 1006, processing continues at operation 1032 when the MBaaS data is set (e.g., included in the synchronization response as part of the response buffer) and a status indicator is set to “Resolve”. Processing then continues to operation 1040 to complete the loop through the synchronization data and the synchronization data processing transaction. If a default conflict resolution policy is configured for the MBaaS 1006, processing continues at operation 1028 by applying a default policy 1026 of Delete_And_Last_Updater_Wins and determining whether the computing device or the MBaaS wins (i.e., by being the last updater) the conflict resolution. If the MBaaS wins, at operation 1030, the MBaaS data is set and a status indicator is set to “overwrite”.

Processing then continues to operation 1040. If the device wins (or if no conflict is detected at operation 1022), processing continues at operation 1034 when the synchronization data is committed to the MBaaS storage. At operation 1036, the version of the committee data is increased. At operation 1038, the new version is also stored in the synchronization response as part of the response buffer, and the status indicator is set to “success” (e.g., to indicate successful completion of the synchronization). At operation 1040, the response buffer is updated, the synchronization data may continue (if the synchronization data includes multiple tuples that have been batched for synchronization) or even all synchronization data has been processed then, at operation 1042, the synchronization data processing transaction ends.

At operation 1048, the network communicates a synchronization response which includes the response buffer and the corresponding status indicators to device 1002. At operation 1050 at device 1002, the device DSM module loops through the response buffer. At operation 1052 it is determined whether the status indicator is set to “success.” If the status indicator is set to “success”, at operation 1058 it is determined whether there is a local commit operation associated with the tuple sent for synchronization. If there is a local commit operation associated with the tuple sent for synchronization, at operation 1064, no data from the response buffer is locally committed. If there is no local commit operation associated with the tuple sent for synchronization, at operation 1066, the local version is updated based on the version received with the response buffer.

If the status indicator is not set to “success”, at operation 1054 it is determined whether the status indicator is set to “overwrite”. If the status indicator is set to “overwrite”, at operation 1060, determine whether there is a local commit operation associated with the tuple sent for synchronization. If there is a local commit operation associated with the tuple sent for synchronization, at operation 1070, the MBaaS data received with the response buffer is discarded. If there is no local commit operation associated with the tuple sent for synchronization, at operation 1068, the MBaaS data received with the response buffer is committed in local storage, overwriting the previously stored version of the data.

If the status indicator is not set to “overwrite”, at operation 1056 it is determined whether the status indicator is set to “resolve”. If the status indicator is not set to “resolve”, then processing continues at operation 1050. If the status indicator is set to “resolve”, then processing continues at operation 1062 when the MBaaS data from the response buffer and the corresponding current local data are returned for resolution based on a custom conflict resolution policy. At operation 1072, the winning data is committed to the local database of device 1002.

Referring to FIG. 10B and FIG. 10C, in aspects, when an additional device 1008 uses the same synchronization data sent by device 1002, at operation 1044, and notification is communicated to the PUB/SUB server. At operation 1046, the PUB/SUB server communicates a notification to a second synchronization server within the MBaaS 1006 via the network 1004. At operation 1088, the second synchronization server communicates a notification to the additional device 1008. At operation 1090, device 1008 obtains a synchronization watermark from its local database storing the corresponding tuples associated with the notification. At operation 1092, device 1008 sends an MBaaS synchronization request, and at operation 1074 receives a response buffer from the MBaaS 1006 with all database table tuples that have versions greater than the watermark communicated by device 1008.

At operation 1076 the DSM module of device 1008 loops through the received response buffer. At operation 1078 it is determined whether a local commit should be performed after the last synchronization (e.g., based on the determination of whether the version numbers of the local data and the data from the response buffer are the same). At operation 1080, if the version numbers are the same, the MBaaS data is committed. If the version numbers are different, at operation 1082, it is determined whether a conflict resolution policy exists and which conflict resolution policy should be used. If a custom conflict resolution policy is active for device 1008, at operation 1086, the winning data is committed to device 1008. If a default conflict resolution policy is active (e.g., a Delete_and_Last_Updater_Wins policy) and if the MBaaS wins, the MBaaS data is committed at operation 1080. Otherwise, if device 1008 wins, the received MBaaS data in the response buffer is discarded at operation 1084.

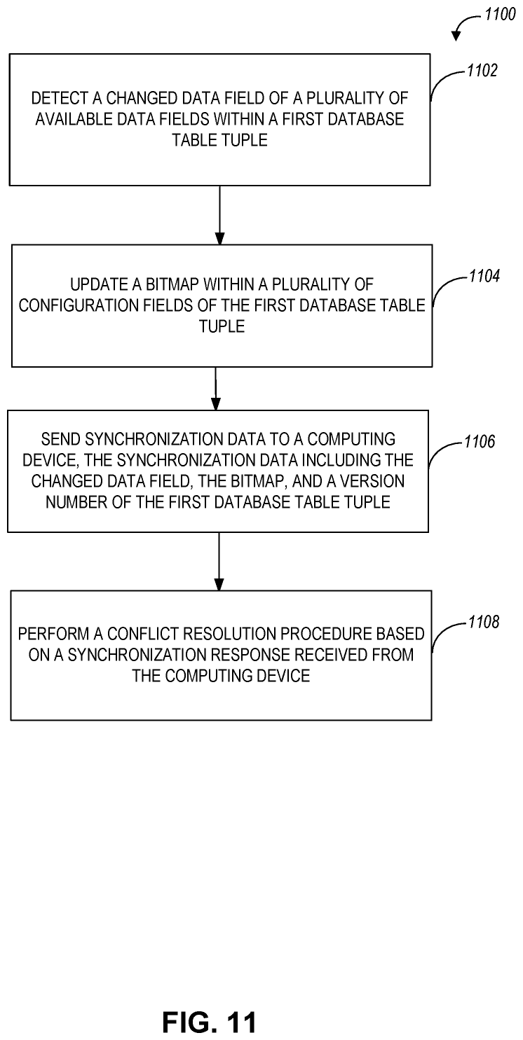

FIG. 11 is a flowchart of a method 1100 suitable for performing data synchronization between a plurality of computing devices within a communication network, according to some example embodiments. Method 1100 includes operations 1102, 1104, 1106, and 1108. By way of example and not limitation, method 1100 may be performed by the device DSM module 804, which is configured to execute within a computing device 802 illustrated in FIG. 8.

Referring to FIG. 11, at operation 1102, a changed data field of a plurality of available data fields within a first database table tuple is detected. At operation 1104, a bitmap within a plurality of configuration fields of the first database table tuple is updated. The bitmap indicates a bit location associated with the changed data fields. For example, the tuple may include 4 data fields, and the bitmap may be 1111 (indicating all four fields are changed), 0000 (indicating all four fields are unchanged), 1000 (indicating only the first field is changed), and so forth.

At operation 1106, synchronization data is communicated to a second computing device of the plurality of computing devices. The synchronization data includes the changed data field, the bitmap, and a version number of the first database table tuple within the plurality of configuration fields. At operation 1108, a conflict resolution procedure is performed based on a synchronization response received from the second computing device. The synchronization response includes status information associated with the synchronization of the changed data field with a second database table tuple of the second computing device based on the version number.

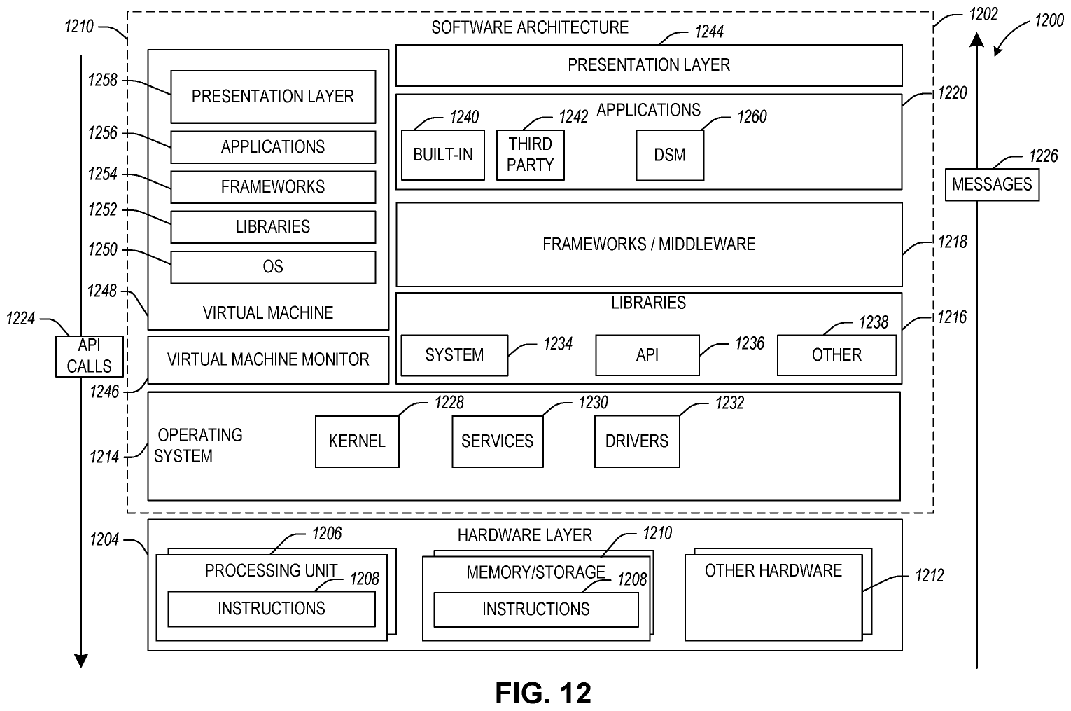

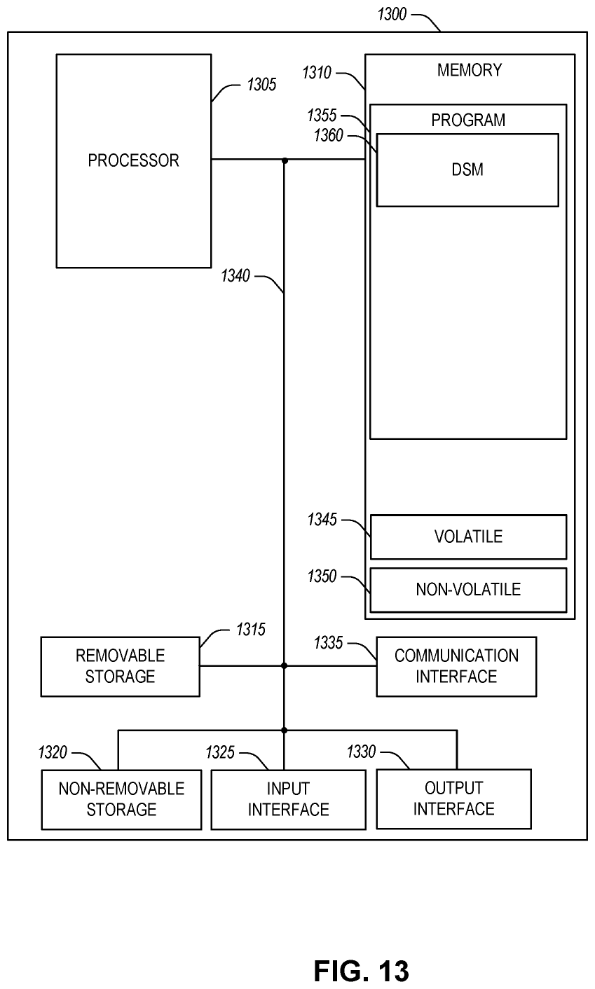

FIG. 12 is a block diagram illustrating a representative software architecture 1200, which may be used in conjunction with various device hardware described herein, according to some example embodiments. FIG. 12 is merely a non-limiting example of software architecture 1202 and it will be appreciated that many other architectures may be implemented to facilitate the functionality described herein. The software architecture 1202 may be executed on hardware such as computing device 1300 of FIG. 13 that includes, among other things, processor 1305, memory 1310, storage 1315 and 1320, and I/O components (or interfaces) 1325 and 1330. A representative hardware layer 1204 is illustrated and can represent, for example, the computing device 1300 of FIG. 13. The representative hardware layer 1204 comprises one or more processing units 1206 having associated executable instructions 1208. Executable instructions 1208 represent the executable instructions of the software architecture 1202, including implementation of the methods, modules, and so forth of FIGS. 1-11. Hardware layer 1204 also includes memory and/or storage modules 1210, which also have executable instructions 1208. Hardware layer 1204 may also comprise other hardware 1212, which represents any other hardware of the hardware layer 1204, such as the other hardware illustrated as part of computing device 1300.

In the example architecture of FIG. 12, the software architecture 1202 may be conceptualized as a stack of layers where each layer provides particular functionality. For example, the software architecture 1202 may include layers such as an operating system 1214, libraries 1216, frameworks/middleware 1218, applications 1220, and presentation layer 1244. Operationally, the applications 1220 and/or other components within the layers may invoke application programming interface (API) calls 1224 through the software stack and receive a response, returned values, and so forth illustrated as messages 1226 in response to the API calls 1224. The layers illustrated in FIG. 12 are representative in nature and not all software architectures 1202 have all layers. For example, some mobile or special purpose operating systems may not provide frameworks/middleware 1218, while others may provide such a layer. Other software architectures may include additional or different layers.

The operating system 1214 may manage hardware resources and provide common services. The operating system 1214 may include, for example, a kernel 1228, services 1230, drivers 1232, and a DSM module 1260. The kernel 1228 may act as an abstraction layer between the hardware and the other software layers. For example, kernel 1228 may be responsible for memory management, processor management (e.g., scheduling), component management, networking, security settings, and so on. The services 1230 may provide other common services for the other software layers. The drivers 1232 may be responsible for controlling or interfacing with the underlying hardware. For instance, the drivers 1232 may include display drivers, camera drivers, Bluetooth® drivers, flash memory drivers, serial communication drivers (e.g., Universal Serial Bus (USB) drivers), Wi-Fi® drivers, audio drivers, power management drivers, and so forth, depending on the hardware configuration.

In some aspects, the DSM module 1260 can be the same as (and perform the same functionalities as) any of the DSM modules discussed in connection with FIGS. 1-11.

The libraries 1216 may provide a common infrastructure that may be utilized by the applications 1220 and/or other components and/or layers. The libraries 1216 typically provide functionality that allows other software modules to perform tasks more easily than to interface directly with the underlying operating system 1214 functionality (e.g., kernel 1228, services 1230, drivers 1232, and/or DSM module 1260). The libraries 1216 may include system libraries 1234 (e.g., C standard library) that may provide functions such as memory allocation functions, string manipulation functions, mathematic functions, and the like. Also, the libraries 1216 may include API libraries 1236 such as media libraries (e.g., libraries to support presentation and manipulation of various media formats such as MPEG4, H.264, MP3, AAC, AMR, JPG, PNG), graphics libraries (e.g., an OpenGL framework that may be used to render 2D and 3D in a graphic content on a display), database libraries (e.g., SQLite that may provide various relational database functions), web libraries (e.g., WebKit that may provide web browsing functionality), and the like. The libraries 1216 may also include a wide variety of other libraries 1238 to provide many other APIs to the applications 1220 and other software components/modules.

The frameworks/middleware 1218 (also sometimes referred to as middleware) may provide a higher-level common infrastructure that may be utilized by the applications 1220 and/or other software components/modules. For example, the frameworks/middleware 1218 may provide various graphical user interface (GUI) functions, high-level resource management, high-level location services, and so forth. The frameworks/middleware 1218 may provide a broad spectrum of other APIs that may be utilized by the applications 1220 and/or other software components/modules, some of which may be specific to a particular operating system 1214 or platform.

The applications 1220 include built-in applications 1240 and/or third-party applications 1242. Examples of representative built-in applications 1240 may include but are not limited to, a contacts application, a browser application, a book reader application, a location application, a media application, a messaging application, and/or a game application. Third-party applications 1242 may include any of the built-in applications 1240 as well as a broad assortment of other applications. In a specific example, the third-party application 1242 (e.g., an application developed using the Android™ or iOS™ software development kit (SDK) by an entity other than the vendor of the particular platform) may be mobile software running on a mobile operating system such as iOS™, Android™, Windows® Phone, or other mobile operating systems. In this example, the third-party application 1242 may invoke the API calls 1224 provided by the mobile operating system such as operating system 1214 to facilitate the functionalities described herein.

The applications 1220 may utilize built-in operating system functions (e.g., kernel 1228, services 1230, drivers 1232, and/or DSM module 1260), libraries (e.g., system libraries 1234, API libraries 1236, and other libraries 1238), and frameworks/middleware 1218 to create user interfaces to interact with users of the system. Alternatively, or additionally, in some systems, interactions with a user may occur through a presentation layer, such as presentation layer 1244. In these systems, the application/module “logic” can be separated from the aspects of the application/module that interact with a user.

Some software architectures utilize virtual machines. In the example of FIG. 12, this is illustrated by virtual machine 1248. A virtual machine creates a software environment where applications/modules can execute as if they were executing on a hardware machine (such as the computing device 1300 of FIG. 13, for example). A virtual machine 1248 is hosted by a host operating system (operating system 1214 in FIG. 12) and typically, although not always, has a virtual machine monitor 1246, which manages the operation of the virtual machine 1248 as well as the interface with the host operating system (i.e., operating system 1214). A software architecture 1202 executes within the virtual machine 1248 such as an operating system 1250, libraries 1252, frameworks/middleware 1254, applications 1256, and/or presentation layer 1258. These layers of software architecture executing within the virtual machine 1248 can be the same as corresponding layers previously described or may be different.

FIG. 13 is a block diagram illustrating circuitry for a device that implements algorithms and performs methods, according to some example embodiments. All components need not be used in various embodiments. For example, clients, servers, and cloud-based network devices may each use a different set of components, or in the case of servers, larger storage devices.

One example computing device in the form of a computer 1300 (also referred to as computing device 1300, computer system 1300, or computer 1300) may include a processor 1305, memory 1310, removable storage 1315, non-removable storage 1320, input interface 1325, the output interface 1330, and communication interface 1335, all connected by a bus 1340. Although the example computing device is illustrated and described as the computing device 1300, the computing device may be in different forms in different embodiments.

Memory 1310 may include volatile memory 1345 and non-volatile memory 1350 and may store a program 1355. The computing device 1300 may include—or have access to a computing environment that includes—a variety of computer-readable media, such as the volatile memory 1345, the non-volatile memory 1350, the removable storage 1315, and the non-removable storage 1320. Computer storage includes random-access memory (RAM), read-only memory (ROM), erasable programmable read-only memory (EPROM) and electrically erasable programmable read-only memory (EEPROM), flash memory or other memory technologies, compact disc read-only memory (CD ROM), digital versatile disks (DVD) or other optical disk storage, magnetic cassettes, magnetic tape, magnetic disk storage or other magnetic storage devices, or any other medium capable of storing computer-readable instructions.

Computer-readable instructions stored on a computer-readable medium (e.g., the program 1355 stored in memory 1310) are executable by the processor 1305 of the computing device 1300. A hard drive, CD-ROM, and RAM are some examples of articles including a non-transitory computer-readable medium such as a storage device. The terms “computer-readable medium” and “storage device” do not include carrier waves to the extent that carrier waves are deemed too transitory. “Computer-readable non-transitory media” includes all types of computer-readable media, including magnetic storage media, optical storage media, flash media, and solid-state storage media. It should be understood that software can be installed on and sold with a computer. Alternatively, the software can be obtained and loaded into the computer, including obtaining the software through a physical medium or distribution system, including, for example, from a server owned by the software creator or from a server not owned but used by the software creator. The software can be stored on a server for distribution over the Internet, for example. As used herein, the terms “computer-readable medium” and “machine-readable medium” are interchangeable.

The program 1355 may utilize one or more modules discussed herein, such as DSM module 1360. In some aspects, the DSM module 1360 can be the same as (and perform the same functionalities as) any of the DSM modules discussed in connection with FIGS. 1-11.

In an example embodiment, the computing device 1300 includes a changed data field detection module detecting a changed data field of a plurality of available data fields within a first database table tuple, a bitmap update module updating a bitmap within a plurality of configuration fields of the first database table tuple, the bitmap indicating a bit location associated with the changed data field, a synchronization data send module sending synchronization data to a second computing device of the plurality of computing devices, the synchronization data including the changed data field, the bitmap, and a version number of the first database table tuple within the plurality of configuration fields, and a conflict resolution module performing a conflict resolution procedure based on a synchronization response received from the second computing device, the synchronization response including status information associated with synchronization of the changed data field with a second database table tuple of the second computing device based on the version number. In some embodiments, the computing device 1300 may include other or additional modules for performing any one of or combination of steps described in the embodiments. Further, any of the additional or alternative embodiments or aspects of the method, as shown in any of the figures or recited in any of the claims, are also contemplated to include similar modules.

Any one or more of the modules described herein may be implemented using hardware (e.g., a processor of a machine, an application-specific integrated circuit (ASIC), field-programmable gate array (FPGA), or any suitable combination thereof). Moreover, any two or more of these modules may be combined into a single module, and the functions described herein for a single module may be subdivided among multiple modules. Furthermore, according to various example embodiments, modules described herein as being implemented within a single machine, database, or device may be distributed across multiple machines, databases, or devices.

Although a few embodiments have been described in detail above, other modifications are possible. For example, the logic flows depicted in the figures do not require the particular order shown, or sequential order, to achieve desirable results. Other steps may be provided, or steps may be eliminated, from the described flows, and other components may be added to, or removed from, the described systems. Other embodiments may be within the scope of the following claims.

It should be further understood that software including one or more computer-executable instructions that facilitate processing and operations as described above concerning any one or all of the steps of the disclosure can be installed in and sold with one or more computing devices consistent with the disclosure. Alternatively, the software can be obtained and loaded into one or more computing devices, including obtaining software through a physical medium or distribution system, including, for example, from a server owned by the software creator or from a server not owned but used by the software creator. The software can be stored on a server for distribution over the Internet, for example.

Also, it will be understood by one skilled in the art that this disclosure is not limited in its application to the details of construction and the arrangement of components outlined in the description or illustrated in the drawings. The embodiments herein are capable of other embodiments and capable of being practiced or carried out in various ways. Also, it will be understood that the phraseology and terminology used herein are for description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. Also, the terms “connected” and “coupled” and variations thereof are not restricted to physical or mechanical connections or couplings. Further, terms such as up, down, bottom, and top are relative and are employed to aid illustration but are not limiting.

The components of the illustrative devices, systems, and methods employed per the illustrated embodiments can be implemented, at least in part, in digital electronic circuitry, analog electronic circuitry, computer hardware, firmware, software, or combinations of them. These components can be implemented, for example, as a computer program product such as a computer program, program code, or computer instructions tangibly embodied in an information carrier, or a machine-readable storage device, for execution by, or to control the operation of, data processing apparatus such as a programmable processor, a computer, or multiple computers.

A computer program can be written in any form of programming language, including compiled or interpreted languages, and it can be deployed in any form, including as a stand-alone program or as a module, component, subroutine, or another unit suitable for use in a computing environment. A computer program can be deployed to be executed on one computer or multiple computers at one site or distributed across multiple sites and interconnected by a communication network. Also, functional programs, codes, and code segments for accomplishing the techniques described herein can be easily construed as within the scope of the claims by programmers skilled in the art to which the techniques described herein pertain. Method steps associated with the illustrative embodiments can be performed by one or more programmable processors executing a computer program, code, or instructions to perform functions (e.g., by operating on input data and/or generating an output). Method steps can also be performed, and apparatus for performing the methods can be implemented as, e.g., special purpose logic circuitry, e.g., an FPGA (field-programmable gate array) or an ASIC (application-specific integrated circuit).

The various illustrative logical blocks, modules, and circuits described in connection with the embodiments disclosed herein may be implemented or performed with a general-purpose processor, a digital signal processor (DSP), an ASIC, an FPGA, or other programmable logic devices, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

Processors suitable for the execution of a computer program include, by way of example, both general and special purpose microprocessors, and any one or more processors of any kind of digital computer. Generally, a processor will receive instructions and data from a read-only memory or a random-access memory, or both. The required elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example, semiconductor memory devices, e.g., electrically programmable read-only memory or ROM (EPROM), electrically erasable programmable ROM (EEPROM), flash memory devices, and data storage disks (e.g., magnetic disks, internal hard disks, or removable disks, magneto-optical disks, and CD-ROM and DVD-ROM disks). The processor and the memory can be supplemented by, or incorporated into special purpose logic circuitry.

Those of skill in the art understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

As used herein, “machine-readable medium” (or “computer-readable medium”) means a device able to store instructions and data temporarily or permanently and may include, but is not limited to, random-access memory (RAM), read-only memory (ROM), buffer memory, flash memory, optical media, magnetic media, cache memory, other types of storage (e.g., Erasable Programmable Read-Only Memory (EEPROM)), and/or any suitable combination thereof. The term “machine-readable medium” should be taken to include a single medium or multiple media (e.g., a centralized or distributed database, or associated caches and servers) able to store processor instructions. The term “machine-readable medium” shall also be taken to include any medium (or a combination of multiple media) that is capable of storing instructions for execution by one or more processors 1305, such that the instructions, when executed by one or more processors 1305, cause the one or more processors 1305 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” as used herein excludes signals per se.

Also, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the scope disclosed herein.

Although the present disclosure has been described regarding specific features and embodiments thereof, it is evident that various modifications and combinations can be made thereto without departing from the scope of the disclosure. For example, other components may be added to, or removed from, the described systems. The specification and drawings are, accordingly, to be regarded simply as an illustration of the disclosure as defined by the appended claims, and are contemplated to cover any modifications, variations, combinations, or equivalents that fall within the scope of the present disclosure. Other aspects may be within the scope of the following claims.

What is claimed is:

1. A computer-implemented method for performing data synchronization between a plurality of computing devices within a communication network, the method comprising:
detecting, by a first computing device of the plurality of computing devices, a changed data field of a plurality of available data fields within a first database table tuple;
updating, by the first computing device, a bitmap within a plurality of configuration fields of the first database table tuple, the bitmap indicating a bit location associated with the changed data field;
sending, by the first computing device, synchronization data to a second computing device of the plurality of computing devices, the synchronization data including the changed data field, the bitmap, and a version number of the first database table tuple within the plurality of configuration fields; and
performing, by the first computing device, a conflict resolution procedure based on a synchronization response received from the second computing device, the synchronization response including status information associated with synchronization of the changed data field with a second database table tuple of the second computing device based on the version number.

2. The computer-implemented method of claim 1, wherein the status information indicates successful completion of a second computing device data synchronization, the synchronization including storing the changed data field in the second database table tuple of the second computing device.

3. The computer-implemented method of claim 2, further comprising:
updating, by the first computing device, the version number within the plurality of configuration fields of the first database table tuple using a version number of the second database table tuple provided by the second computing device in the synchronization response, the updating being based on the successful completion of the second computing device data synchronization, and the version number of the second database table tuple being higher than the version number of the first database table tuple.

4. The computer-implemented method of claim 1, further comprising:
determining, by the first computing device, that a conflict exists when a version number of the second database table tuple provided by the second computing device in the synchronization response is higher than the version number of the first database table tuple.

5. The computer-implemented method of claim 4, the synchronization response including the version number of the second database table tuple and data from the second database table tuple, and the method further comprising:
updating the plurality of available data fields in the first database table tuple with the data from the second database table tuple; and
updating the version number of the first database table tuple using the version number of the second database table tuple.

6. The computer-implemented method of claim 1, wherein the plurality of configuration fields includes synchronization state information associated with the first database table tuple, the synchronization state information indicating one of:
the first database table tuple has changed and has to synchronize with the second computing device;
an ongoing synchronization of the first database table tuple with the second computing device; or
the first database table tuple was previously synchronized, without a need for a current synchronization.

7. The computer-implemented method of claim 6, the method further comprising:
performing the conflict resolution procedure based on the synchronization response received from the second computing device and the synchronization state information associated with the first database table tuple.

8. The computer-implemented method of claim 7, wherein the bitmap includes a plurality of bits corresponding to the plurality of available data fields within the first database table tuple, each bit of the plurality of bits indicating when a corresponding data field of the plurality of available data fields within the first database table tuple has been changed.

9. The computer-implemented method of claim 8, wherein the first database table and the second database table are secure databases associated with:
a common user of the first computing device and the second computing device; and
a common application executing on the first computing device and the second computing device.

10. A system for performing data synchronization between a plurality of computing devices within a communication network, the system comprising:
a memory storing instructions; and
one or more processors in communication with the memory, the one or more processors configured, upon execution of the instructions, to perform the following steps:
detect a changed data field of a plurality of available data fields within a first database table tuple associated with a first computing device of the plurality of computing devices;
update a bitmap within a plurality of configuration fields of the first database table tuple, the bitmap indicating a bit location associated with the changed data field;
send synchronization data to a second computing device of the plurality of computing devices, the synchronization data including the changed data field, the bitmap, and a version number of the first database table tuple within the plurality of configuration fields; and
perform a conflict resolution procedure based on a synchronization response received from the second computing device, the synchronization response including status information associated with the synchronization of the changed data field with a second database table tuple of the second computing device based on the version number.

11. The system of claim 10, wherein the status information indicates successful completion of a second computing device data synchronization, the synchronization including storing the changed data field in the second database table tuple of the second computing device.

12. The system of claim 11, wherein the one or more processors execute the instructions to:
update the version number within the plurality of configuration fields of the first database table tuple using a version number of the second database table tuple provided by the second computing device in the synchronization response, the updating being based on the successful completion of the second computing device data synchronization, the version number of the second database table tuple being higher than the version number of the first database table tuple.

13. The system of claim 10, wherein the one or more processors execute the instructions to:
determine that a conflict exists when a version number of the second database table tuple provided by the second computing device in the synchronization response is higher than the version number of the first database table tuple.

14. The system of claim 13, wherein the synchronization response includes the version number of the second database table tuple and data from the second database table tuple, and wherein the one or more processors execute the instructions to:
update the plurality of available data fields in the first database table tuple with the data from the second database table tuple; and
update the version number of the first database table tuple using the version number of the second database table tuple.

15. The system of claim 10, wherein the plurality of configuration fields includes synchronization state information associated with the first database table tuple, the synchronization state indicating one of:
the first database table tuple has changed and has to synchronize with the second computing device;
an ongoing synchronization of the first database table tuple with the second computing device; or
the first database table tuple was previously synchronized, without a need for a current synchronization.

16. The system of claim 15, wherein the one or more processors execute the instructions to:
perform the conflict resolution procedure based on the synchronization response received from the second computing device and the synchronization state information associated with the first database table tuple;
wherein the bitmap includes a plurality of bits corresponding to the plurality of available data fields within the first database table tuple, each bit of the plurality of bits indicating whether a corresponding data field of the plurality of available data fields within the first database table tuple has been changed.

17. A computer-readable medium storing computer instructions for performing data synchronization between a plurality of computing devices within a communication network, the instructions configure one or more processors, upon execution of the instructions, to perform the following steps:
detect a changed data field of a plurality of available data fields within a first database table tuple associated with the first computing device;
update a bitmap within a plurality of configuration fields of the first database table tuple, the bitmap indicating a bit location associated with the changed data field;
send synchronization data to a second computing device of the plurality of computing devices, the synchronization data including the changed data field, the bitmap, and a version number of the first database table tuple within the plurality of configuration fields; and
perform a conflict resolution procedure based on a synchronization response received from the second computing device, the synchronization response including status information associated with the synchronization of the changed data field with a second database table tuple of the second computing device based on the version number.

18. The computer-readable medium of claim 17, wherein the instructions further cause the one or more processors to:
determine that a conflict exists when a version number of the second database table tuple provided by the second computing device in the synchronization response is higher than the version number of the first database table tuple.

19. The computer-readable medium of claim 18, the synchronization response including the version number of the second database table tuple and data from the second database table tuple, and wherein the instructions further cause the one or more processors to:
update the plurality of available data fields in the first database table tuple with the data from the second database table tuple; and
update the version number of the first database table tuple using the version number of the second database table tuple.

20. The computer-readable medium of claim 18, wherein the plurality of configuration fields includes synchronization state information associated with the first database table tuple, the synchronization state indicating one of the first database table tuple has changed and has to synchronize with the second computing device, an ongoing synchronization of the first database table tuple with the second computing device, or the first database table tuple was previously synchronized, without a need for a current synchronization, and wherein the instructions further cause the one or more processors to:
perform the conflict resolution procedure based on the synchronization response received from the second computing device and the synchronization state information associated with the first database table tuple;
wherein the bitmap includes a plurality of bits corresponding to the plurality of available data fields within the first database table tuple, each of the plurality of bits indicating whether a corresponding data field of the plurality of available data fields within the first database table tuple has been changed.
